(19) United States
(12) Patent Application Publication
(10) Pub. No.: US 2012/0086317 A1
(43) Pub. Date: Apr. 12, 2012

(54) TOE KICK STEP STOOL

(76) Inventor: Jason S. Baran, DOVER, NJ (US)

(21) Appl. No.: 13/269,034

(22) Filed: Oct. 7, 2011

Related U.S. Application Data
(60) Provisional application No. 61/391,104, filed on Oct. 8, 2010.

(51) Int. Cl. A47B 83/00; B23P 17/04

(52) U.S. Cl. 312/237; 29/401.1

(57) ABSTRACT

A system and apparatus which provides on demand step stool functionality without wasting valuable storage space. More particularly, a toe kick step stool system is disclosed which, when actuated, emerges from under a cabinet to provide a stable standing surface.

### CROSS-REFERENCE TO RELATED APPLICATIONS

This application claims priority to U.S. Provisional Patent Application No. 61/391,104, filed on Oct. 8, 2010, entitled “Toe Kick Step Stool,” by Jason S. Baran, which is hereby incorporated by reference.

### TECHNICAL FIELD

The present disclosure relates to cabinets and general cabinetry. More specifically, the present invention relates to toe kick drawers having an integral step ladder and methods that utilize typically wasted space under cabinets.

### BACKGROUND

Nearly every residence has some form of built-in or custom cabinetry. Typically found in kitchens, bathrooms and pantries, these cabinets serve a variety of aesthetic and utilitarian purposes. Modern cabinetry is not merely meant to store goods, but also to maximize storage capability and function while being pleasing to the eye.

Over the past few decades, modern kitchen design has improved partly as a result of ergonomic research. However, functionality is the primary consideration. According to the August 2006 issue of KITCHEN & BATH DESIGN NEWS, in an effort to find innovative new ways to organize America's kitchens, researchers from Diamond Cabinets worked side by side with anthropological scientists to observe how homeowners “interact” with their kitchen cabinets. Diamond Cabinets concluded that “the kitchen is the most utilized, multi-tasked space in the entire house, so cabinets need to be as multi-functional as the kitchen and as utilitarian as a Swiss Army Knife.”

Today's kitchens are larger and have more cabinets (some as many as 50 drawers and cabinet doors). New features today include deep drawers for cookware, pull-out shelves to avoid excess bending, sponge trays on the front of sink cabinets, pullout hideaway garbage/recycling containers, pull-out spice cabinets, lazy susans in corner cabinets, vertical storage for cookie sheets, full-extension drawer slides, and drawers and doors with so-called soft-close/positive-close mechanisms enabling drawers to shut quietly, or which shut fully after being pushed only partially.

The Diamond Cabinets' research also revealed that people conceptualize “wasted space” as a very bad thing and want to use every nook and cranny in their kitchens, regardless of how much storage space they actually have, emphasizing the need for cabinets to carve out space where none existed before. A toe kick is the recess or indentation at the bottom of a cabinet, which provides room to allow the user to stand closer without “kicking the toe.” This area is normally closed off by a front kick plate and is generally regarded as wasted space of cabinet structure. For example, a new “Toe Kick Cabinet” creates extra storage space beneath base cabinets, just above the floor. A tap with a toe on the front plate of the drawer opens a hidden storage compartment. However, a simple drawer does not provide enough utility for today's kitchens.

The modem kitchen not only bigger, but is also taller than kitchens of yesteryear. As kitchens grow, builders attempt to increase storage capability and the overall appearance of kitchens by increasing the height of cabinets.

Base cabinets are traditionally around 34.5″ (inches) tall with a 1.5″ counter top. Taking into account the backsplash (typically around 18″), bottom-of-the-wall cabinets are mounted approximately 54″ off the floor (where the toe kick is approximately 3″ to 4″). Wall cabinets range from traditional sizes of 30″, 33″, 36″ and 42″, while custom cabinets may have more varied heights available. Once complete, the top of a traditional kitchen cabinet can range from 84″ to 96″, with custom cabinets potentially being even taller.

Although these tall kitchens are great for storage and appearance, actually accessing or reaching the top shelf of the top cabinet can be quite difficult. This is simply because the height of the cabinet is substantially taller than the average person (the average American male is 70 inches tall, while the average American female is 64 inches tall).

As a result, a homeowner with tall cabinets has limited options to avoid wasting use of the top shelf. The most common solution is to keep a step stool or ladder in or near the kitchen. A loose step stool is not ideal because storage of the stool can be a hassle. Similarly, building and/or setting up the step stool can be a hassle when busy or carrying items. Also, a loose stool is often not stable during use, which presents a hazard for slip-and-fall injuries to its users.

Therefore, there is a need for a system and apparatus that provides on demand step stool functionality without wasting valuable storage space. There is a need for a system and apparatus that provides on demand step stool functionality without wasting valuable storage space. More particularly, there is a need for a toe kick step stool system that, when needed, emerges from under a cabinet to provide a stable standing surface. There is also a need for methods of utilizing normally wasted space for functional purposes.

### SUMMARY OF THE INVENTION

There are numerous advantages associated with the toe kick step stool systems of the present invention that simply cannot be accomplished using traditional methods. For example, embodiments of the present invention are far more stable than traditional step stools due, in part, to the step stool being attached to a stationary cabinet and a drawer that provides a sturdy base and/or foundation. Another advantage of embodiments of the present invention is that they eliminate a need to allocate precious storage space for a bulky traditional step stool. Instead, embodiments of the invention occupy spaces under cabinets that are traditionally wasted. Further, in a fully automated embodiment, users of the present invention would only need to trigger one or more actuators (e.g., via button, switch, remote control or traditional mechanical methods), which can eliminate the need to bend over to open the drawer and/or set up the step stool. Fully automated embodiments of the present invention would be particularly beneficial to the elderly and those plagued with back troubles. Finally, embodiments of the present invention can be installed into existing cabinetry, eliminating the time and money costs of replacing existing cabinets.

According to a first aspect of the present invention, a toe kick step stool system is described. The toe kick step stool system comprising a cabinet structure having a hollow space capable of slidably receiving a toe kick drawer and a step stool pivotally connected to the toe kick drawer at one or more points wherein the toe kick drawer is capable of being actuated by a user.

According to a second aspect of the present invention, a method of modifying an existing cabinet structure to include a toe kick step stool is taught. The method comprising the steps of: removing a toe kick plate from a cabinet to expose the toe kick area, slidably mounting a toe kick drawer within the toe kick area of cabinet and pivotally connecting a step stool to the toe kick drawer at one or more points. Wherein the step stool is capable of supporting the weight of a user while the toe kick drawer is in an open position.

According to a third aspect of the present invention, a toe kick step stool system is described. The toe kick step stool system comprising a toe kick drawer having two side panels, a front panel, a back panel and a bottom panel; a cabinet structure having a hollow space equipped with one or more drawer rails for slidably receiving the toe kick drawer; a collapsible step stool having a flat step portion and at least one set of pivotally connected legs, wherein the collapsible step stool is pivotally connected to the toe kick drawer at one or more points allowing the collapsible step stool, while in a collapsed position, to swing up and out of the toe kick drawer and to open to a locked position and one or more actuators for sliding the toe kick drawer to an extended open position.

According to fourth aspect of the present invention, the toe kick step stool system may further comprise concealed magnetic push-to-close latches.

According to fifth aspect of the present invention, the toe kick step stool system's actuators may include gas-springs.

### DESCRIPTION OF THE DRAWINGS

These and other advantages of the present invention will be readily understood with reference to the following specification and attached drawings wherein:

FIG. 1A is a side perspective view of a first embodiment of a toe kick step stool system of the present invention in the open position;

FIG. 1B is a side perspective view of a first embodiment of a toe kick step stool system of the present invention in the closed position;

FIG. 1C is an underside perspective view of a first embodiment of a toe kick step stool system of the present invention in the open position;

FIG. 2A is a side perspective view of a first embodiment of the toe kick step stool system of the present invention in the collapsed position;

FIG. 2B is a side perspective view of a first embodiment of the toe kick step stool system of the present invention in the upright position;

FIG. 2C is a side perspective view of a first embodiment of the toe kick step stool system of the present invention in the upright locked position;

FIG. 3A is a side perspective view of a first embodiment of the toe kick step stool system of the present invention in the process of being unlocked;

FIG. 3B is a side perspective view of a first embodiment of the toe kick step stool system of the present invention in the upright position; and

FIG. 3C is a side perspective view of a first embodiment of the toe kick step stool system of the present invention in the collapsed position.

### DETAILED DESCRIPTION

Preferred embodiments of the present invention will be described hereinbelow with reference to the accompanying drawings. In the following description, well-known functions or constructions are not described in detail because they would obscure the invention in unnecessary detail.

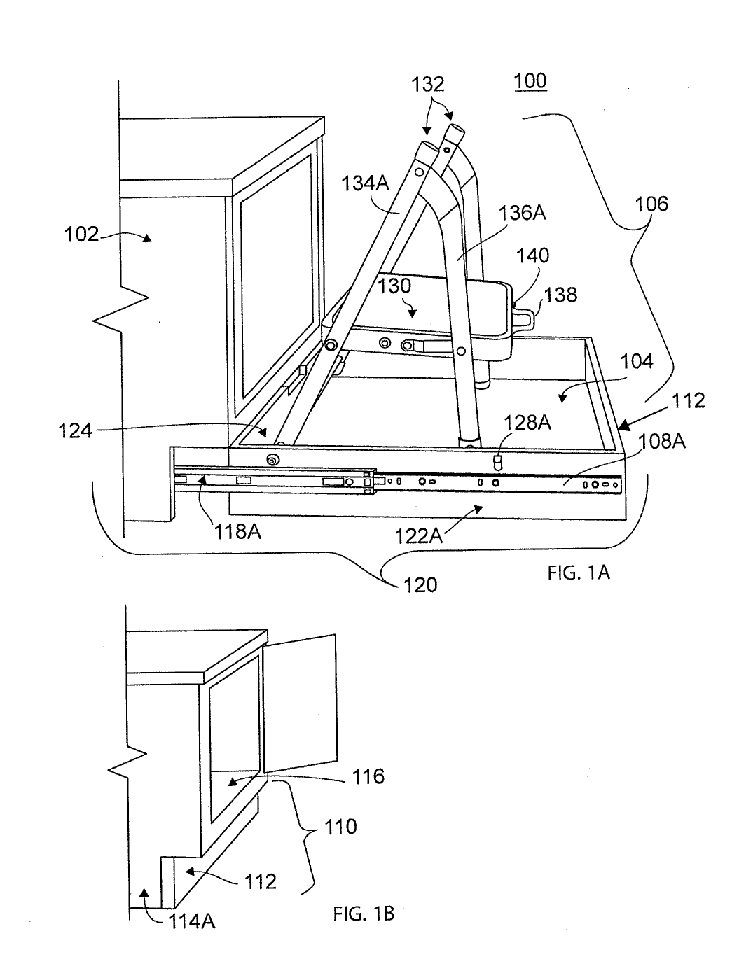

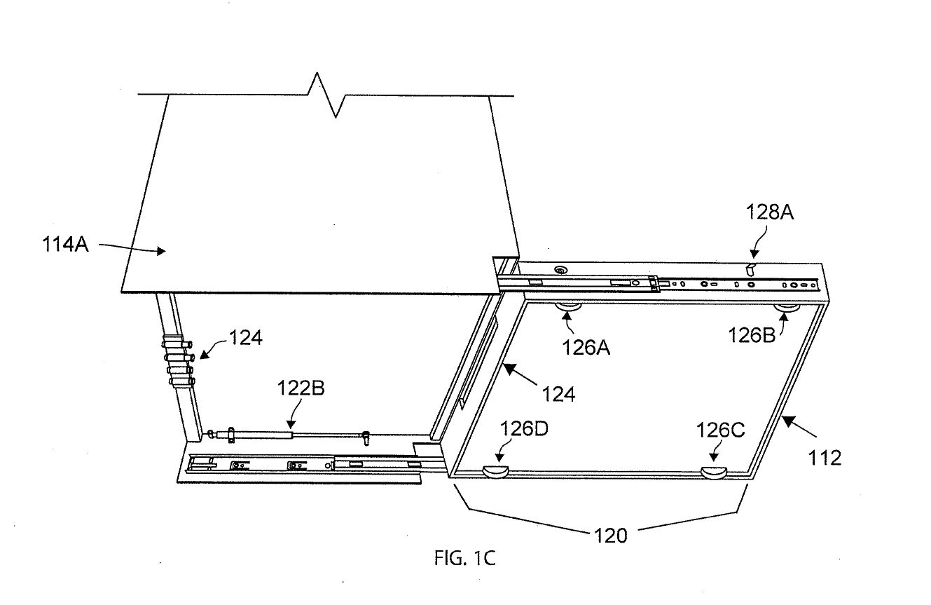

Referring now to FIGS. 1A and 1B, a side perspective view of a first embodiment of toe kick step stool system 100 is shown integrated with traditional floor kitchen cabinet 102. Kitchen cabinet 102 will be used in the following examples; however, toe kick step stool system 100 may be integrated with, or coupled to, any other floor-based cabinets or furniture. Toe kick step stool system 100 is generally comprised of toe kick drawer 120; step stool assembly 106, where the toe kick drawer 120 may be insertably/slideably coupled (e.g., by drawer tracks 108) to a cabinet 102; and may further include a mechanism for actuating the step stool assembly.

The cabinet 102 can include toe kick area 110, which may be a cavity formed by toe kick plate 112, side walls 114A, 114B, rear wall, floor and cabinet base 116. Toe kick area 110 includes a first 118A and second track 118B mounted on side walls 114A, 114B for insertably connecting a toe kick drawer 120 therethrough.

Toe kick drawer 120 can be configured to occupy the cabinet's toe kick area 110. In a preferred embodiment, toe kick drawer 120 may be comprised of five panels (two side panels 122A, 122B, front panel 112, back panel 124 and bottom panel 104). However, fewer panels may be used (particularly if certain panels may be substituted with reinforcement means (e.g., rods, bars, etc.)). Toe kick drawer 120 can further include a first 108A and second 108B track mounted on the outer side walls 122A, 122B for slidably mounting within toe kick area 110. A suitable toe kick drawer apparatus is disclosed in U.S. Pat. No. 6,364,441 to Arnold, which is hereby incorporated by reference in its entirety herein. Arnold teaches a toe kick drawer and method, which includes installation of a first and second track for insertably connecting a drawer. However, the Arnold disclosure teaches an inferior spring-loaded drawer propulsion mechanism that relies on metal spring coils mounted between the back of the drawer and the wall. Similarly, the drawer does not make contact with the ground when open, thus causing the tracks to bear the entire weight of the drawer and drawer contents. Various embodiments of the present invention can overcome both of these problems.

Referring now to FIG. 1C, a user need only tap or push front panel 112 with their foot to open toe kick drawer 120 will open, therefore eliminating any need to bend over. This operation may be accomplished, for example, using concealed magnetic push-to-close latches 224 and/or gas springs/struts 122. In a preferred embodiment, the concealed magnetic push-to-close latches 224 are mounted at, or near, the back wall of the cabinet 102 and configured to make contact with a metal plate, or area, installed on back wall 124 when drawer 120 is in the closed position. Gas springs 122A, 122B may be used to push drawer 120 to a fully extended open position when drawer front 112 has been tapped (which in turn releases the concealed magnetic push-to-close latches 224). Traditional springs may also be used. However, a gas spring is preferred since it is far more reliable and does not suffer the same limitations that traditional springs have. For example, when a traditional spring is compressed for an extended period of time, the spring may retain the compressed state (or partially compressed state), and therefore not fully or sufficiently extend when needed. Using a gas spring eliminates these risks and may extend the life and reliability of the product. In a preferred embodiment, two gas springs 122A, 122B are mounted on the inner portion of sides 114A, 114B wherein gas springs 122A, 122B are generally comprised of a cylinder configured to house a piston rod. As depicted in FIG. 1C, the cylinder end may be fixedly attached to sides 114A, 114B, allowing the piston-rod end to freely extend/compress when the drawer is opened/closed. In operation, the piston-rod end of gas springs 122A, 122B may be in direct contact with a portion of the drawer 120, allowing the drawer 120 to be pushed out as gas springs 122A, 122B extend. Similarly, when the drawer 120 is being closed, a portion of the drawer 120 may push the piston-rod end until the drawer is closed and the gas spring is compressed. In the depicted configuration, protrusion 128A, 128B is mounted on each drawer side 122A, 122B above the rails 122A, 122B. Protrusions 128A, 128B may act as the portion of the drawer 120 that contacts and is pushed by or compresses the piston-rod end of the gas springs 122A, 122B. In alternative embodiments, in lieu of or in addition to the gas spring system, a simple pull handle may be mounted on the front panel to pull the drawer out.

As depicted in FIG. 1 C, the underside of the toe kick drawer may also include a means for sliding across the floor surface (e.g., wheels, castors, polymer plastic slider, etc.). In a preferred embodiment, the drawer includes four plastic wheels 126 on the underside of drawer 120. Plastic wheels 126 should have a low profile such that drawer 120 is not in contact with the floor to avoid scraping or contact with the floor. Once weight is applied to drawer bottom 104 by a user stepping on step stool 106, drawer bottom 104 may make contact with the floor to lessen strain on drawer rails 108, 118. In certain embodiments, particularly where very low profile wheels cannot be used (e.g., on carpet), wheels may retract into the drawer when weight is applied (e.g., using springs), leaving drawer bottom 120 in direct contact with the floor. In these embodiments, the wheels may return to their non-retracted state when weight is removed from step stool 106.

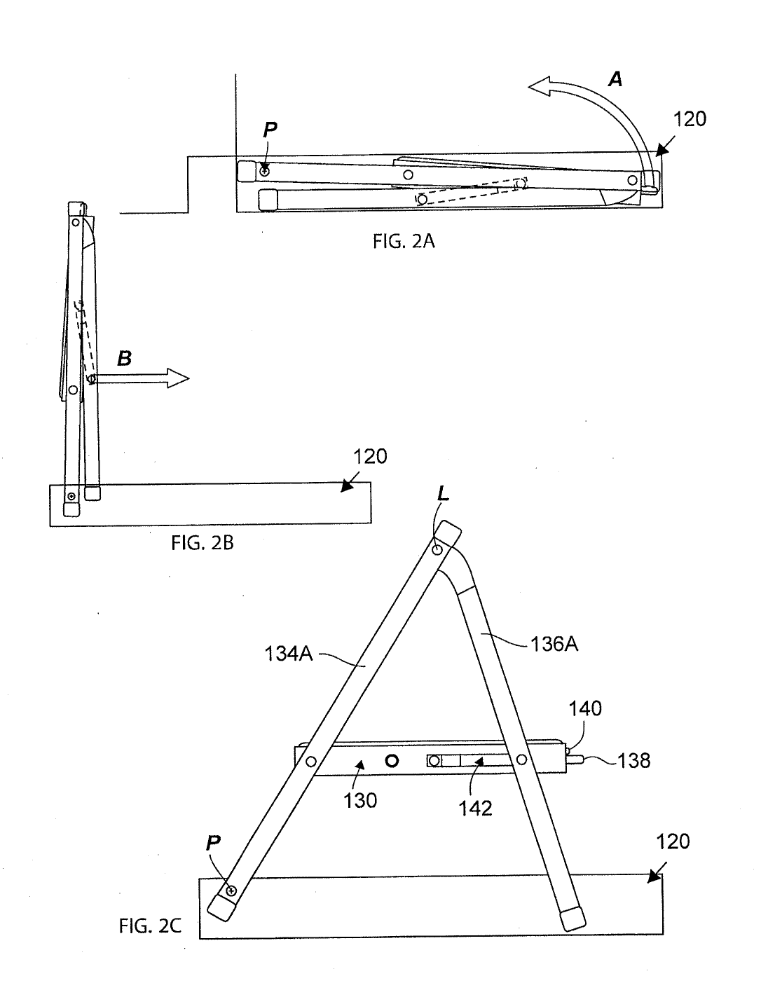

Referring now to FIGS. 1A and 2C, step stool 106 may be comprised of a flat step portion 130 and two pivotally connected leg sets 132. However, the step stool may include multiple steps to attain a greater height. Each leg set 132 is generally comprised of two legs (e.g., tubular metal legs) pivotally connected end-to-end at point L. The step stool 106 may include longer, substantially straight legs 134A, 134B, and shorter legs 136A, 136B that may be curved near the pivot point, allowing the step stool to fold flat. Also, in a preferred embodiment, handle 138 and release button 140 are mounted on step portion 130. The substantially straight legs 134A, 134B of step stool 106 can be pivotally connected to drawer 120 at point P. As shown in the figures, the step stool can further include various brackets and connectors necessary for folding the step stool.

Now referring to FIGS. 2A-2C, exemplary steps for setting up the step stool in certain embodiments are shown. FIG. 2A is a side perspective view of the toe kick step stool system in the collapsed position. In one embodiment, to manually set up the stool, a user may pull the folded stool in direction A (e.g., by handle 138) upward and out of drawer 120. The folded ladder can pivot at point P until the folded ladder is approximately perpendicular to drawer 120. As shown in FIG. 2B, the user may pull shorter legs 136A, 136B away from longer legs 134A, 134B in direction B. FIG. 2C is a side perspective view of the toe kick step stool system in the upright locked position with bracket 142 parallel to drawer 120 and the stool 106 is locked in the open position.

In this position, a user may use the toe kick step stool system 100 by stepping on step portion 130 of step stool 106. Once a user has mounted step stool 106, the user is able to reach items that the user would not have been previously able to reach. Once the user's weight is applied to drawer bottom 104 (by stepping on step stool 106), drawer bottom 104 may make contact with the floor to provide a larger footprint that provides additional stability (e.g., by providing substantially greater contact with the floor). This larger footprint can also prevent wear on the underlying floor from repeated use.

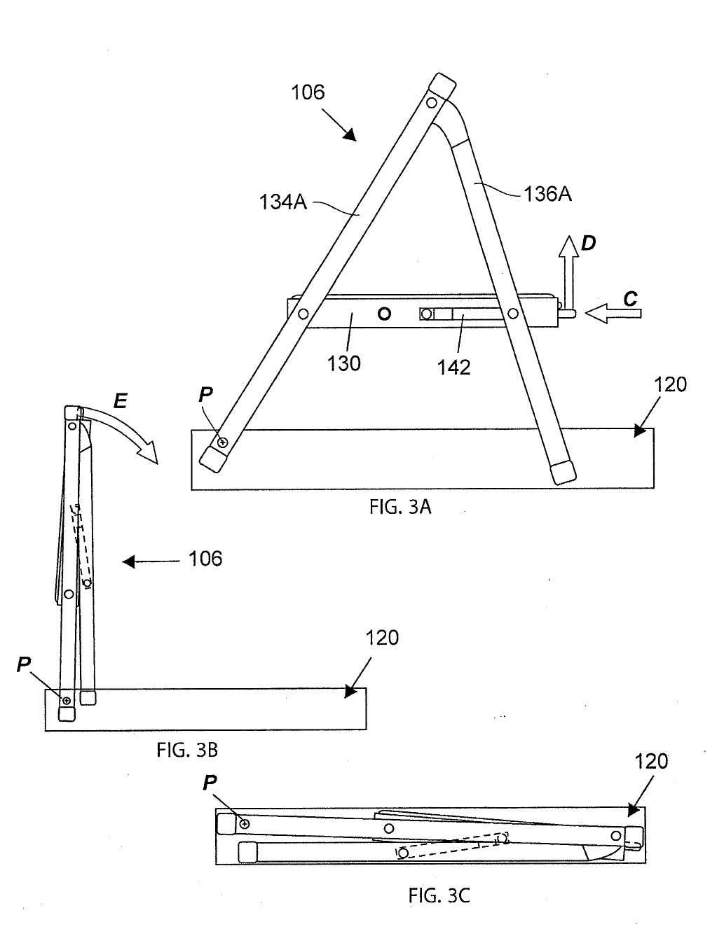

Now referring to FIGS. 3A-3C, exemplary steps for collapsing the step stool of certain embodiments are shown. FIG. 3A is a side perspective view of the toe kick step stool system 100 in the locked position. In a preferred embodiment, the user may first unlock the stool by depressing release button 140 in direction C. Once release button 140 has been pressed, the user need only pull step portion 130 upward in direction D (e.g., by pulling handle 138 upward) until legs 134 and 136 are substantially parallel to each other and are substantially perpendicular to drawer 120. As shown in FIG. 3B, now-folded step stool 106 may be stored in drawer 120 by swinging step stool 106 downward in direction E such that it completely collapsed as show in FIG. 3C.

In another embodiment, electronic actuators are used to slide drawer 120 out of toe kick area 110. This configuration would substantially mimic that of the first embodiment (FIGS. 1A-1C), except electric actuators would be installed in lieu of gas springs. In this embodiment, the actuators may be controlled or activated by a traditional in-wall switch or push button. Alternatively, a remote control may be used to trigger a sensor, which will then provide power to the actuator, causing drawer 120 to slide outward.

Similarly, electric actuators may also be used to set-up step stool 106. One or more actuators can be installed in the drawer that, when activated, cause legs 134 and 136 to separate (e.g., by pushing them apart) until the step stool is in the complete upright position. When actuators are used, a mechanical locking mechanism may not be necessary. In these embodiments, the user would only need to return the actuator to its original position to collapse the step stool 106. The actuators may be controlled or activated by a traditional in-wall switch or push button. Alternatively, a remote control may be used to trigger a sensor that will then provide power to the actuator, causing the step stool to automatically collapse.

In situations where the drawer and step stool are both controlled by actuators, the entire system may be configured so that the user need only press a single button (e.g., in-wall switch, button or remote control) to automatically actuate the toe kick step stool. First, the drawer will first automatically slide out into the open position, then the step stool will automatically move into the upright and open position. Upon a subsequent press of the same button, the actuators will then return to their original position (however, in the reverse order such that the stool collapses before the drawer slides back in), thus completely streamlining the procedure. This embodiment would completely remove bending or lifting by the user.

In yet another embodiment, toe kick step stool system 100 may be incorporated into a simple base structure where the base structure is designed to support substantial weight. In this embodiment, various appliances (e.g., dishwasher, compactor, oven, range, refrigerator, etc.) may be installed on top of the base structure. This arrangement would be particularly beneficial in situations where a traditional base cabinet cannot be used, but there are tall wall cabinets above the cabinet. This would also be helpful for children to facilitate their hand washing and to reach the top shelves of a refrigerator. Similarly, this embodiment would be beneficial in compact apartments where washers and dryers are often stacked.

The toe kick step stool system 100 may be particularly useful in closets and bedrooms. Modern closets often include custom cabinetry; and integration of embodiments of the present invention would allow greater access to higher up shelves. The embodiments of the present invention may also be integrated with the base of a bed to make entering a taller bed (e.g., bunk beds and platform beds) easier for children and elderly people.

Although various embodiments have been described with reference to a particular arrangement of parts, features and the like, these are not intended to exhaust all possible arrangements or features, and indeed many other embodiments, modifications and variations will be ascertainable to those of skill in the art.

What is claimed is:

1. A toe kick step stool system comprising:
a cabinet structure having a hollow space capable of slidably receiving a toe kick drawer; and
a step stool pivotally connected to the toe kick drawer at one or more points wherein the toe kick drawer is capable of being actuated by a user.

2. The toe kick step stool system of claim 1, wherein the toe kick drawer has two side panels, a front panel, a back panel and a bottom panel.

3. The toe kick step stool system of claim 1, wherein the step stool is a collapsible step stool having a flat step portion and at least one set of pivotally connected legs, wherein the collapsible step stool is pivotally connected to the toe kick drawer at one or more points allowing the collapsible step stool, while in a collapsed position, to swing up and out of the toe kick drawer and to open to a locked position.

4. The toe kick step stool system of claim 1, further comprising concealed magnetic push-to-close latches.

5. The toe kick step stool system of claim 1, further comprising one or more actuators for sliding the toe kick drawer to an extended open position.

6. The toe kick step stool system of claim 5, wherein said one or more actuators include gas-springs.

7. The toe kick step stool system of claim 5, wherein said one or more actuators include electric actuators.

8. A method of modifying an existing cabinet structure to include a toe kick step stool comprising the steps of:
removing a toe kick plate from a cabinet to expose the toe kick area;
slidably mounting a toe kick drawer within the toe kick area of cabinet; and
pivotally connecting a step stool to the toe kick drawer at one or more points wherein the step stool is capable of supporting the weight of a user while the toe kick drawer is in an open position.

9. The method of claim 8, wherein the toe kick drawer has two side panels, a front panel, a back panel and a bottom panel.

10. The method of claim 8, wherein the step stool is a collapsible step stool having a flat step portion and at least one set of pivotally connected legs, wherein the collapsible step stool is pivotally connected to the toe kick drawer at one or more points allowing the collapsible step stool, while in a collapsed position, to swing up and out of the toe kick drawer and to open to a locked position.

11. The method of claim 8, further comprising concealed magnetic push-to-close latches.

12. The method of claim 8, further comprising one or more actuators for sliding the toe kick drawer to an extended open position.

13. The method of claim 12, wherein said one or more actuators include gas-springs.

14. The method of claim 12, wherein said one or more actuators include electric actuators.

15. A toe kick step stool system comprising:
a toe kick drawer having two side panels, a front panel, a back panel and a bottom panel;
a cabinet structure having a hollow space equipped with one or more drawer rails for slidably receiving the toe kick drawer;
a collapsible step stool having a flat step portion and at least one set of pivotally connected legs, wherein the collapsible step stool is pivotally connected to the toe kick drawer at
one or more points allowing the collapsible step stool, while in a collapsed position, to swing up and out of the toe kick drawer and to open to a locked position; and
one or more actuators for sliding the toe kick drawer to an extended open position.

16. The system of claim 15 further comprising concealed magnetic push-to-close latches.

17. The system of claim 15, wherein said one or more actuators include gas-springs.
